(19) United States
(12) Patent Application Publication
(10) Pub. No.: US 2019/0276923 A1
(43) Pub. Date: Sep. 12, 2019

(54) METHOD FOR MANUFACTURING METAL MOLDED ARTICLE

(71) Applicant: MITSUBISHI HEAVY INDUSTRIES, LTD., Tokyo (JP)

(72) Inventors: Shuji TANIGAWA, Tokyo (JP); Masashi KITAMURA, Tokyo (JP); Kosuke FUJIWARA, Tokyo (JP); Toshinobu OHARA, Tokyo (JP); Masaki TANEIKE, Tokyo (JP); Takahiro FUKUDA, Tokyo (JP)

(21) Appl. No.: 16/266,322

(22) Filed: Feb. 4, 2019

(30) Foreign Application Priority Data
Mar. 9, 2018 (JP) 2018-042458

(51) Int. Cl. C23C 4/18; C23C 4/02; C23C 4/11; C23C 4/134

(52) U.S. Cl. CPC C23C 4/18; C23C 4/02; B33Y 80/00; C23C 4/134; C23C 4/11

(57) ABSTRACT

Provided is a method for manufacturing a metal molded article capable of suppressing leaching of a molten liquid that may be created due to heat treatment of a metal member, from the metal member. The method for manufacturing a metal molded article includes the steps of: applying a ceramic coating to a metal member; and performing heat treatment of the metal member to which the ceramic coating has been applied.

### TECHNICAL FIELD

The present disclosure relates to a method for manufacturing a metal molded article.

### BACKGROUND

Heat treatment may be performed on a metal molded article in order to change the characteristics of the metal molded article. For example, Patent Document 1 discloses a technique of subjecting a metal molded article, obtained by 3D additive manufacturing (metal additive manufacturing), to heat treatment at a temperature equal to or higher than a recrystallization temperature of a metal material for the purpose of reducing anisotropy characteristics in both horizontal and vertical directions.

### CITATION LIST

### Patent Literature

Patent Document 1: Japanese Patent No. 5901585

### SUMMARY

In order to change the characteristics of a metal molded article, the metal molded article may be subjected to heat treatment at a high temperature near or higher than a solidus temperature of a composition of the metal molded article. When such heat treatment is performed on a metal molded article, a grain boundary with a low melting point may partially melt. As shown in FIG. 4, when partial melting of a grain boundary with a low melting point occurs, problems arise such as leaching of a molten liquid 102 from a surface 101 of a metal member 100 causing a defect 103 to be created inside the metal member 100.

In consideration of the circumstances described above, an object of at least one embodiment of the present disclosure is to provide a method for manufacturing a metal molded article capable of suppressing leaching of a molten liquid that may be created due to heat treatment of a metal member from the metal member.

(1) A method for manufacturing a metal molded article according to at least one embodiment of the present invention includes the steps of:

preparing a metal member;

applying a ceramic coating to the metal member; and

performing heat treatment of the metal member to which the ceramic coating has been applied, wherein

a temperature T1 [° C.] in the step of performing heat treatment is expressed by (Ts−70)≤T1≤Ts+30, where Ts [° C.] denotes a solidus temperature of a composition of the metal member.

According to the method for manufacturing in (1) described above, even when a molten liquid is created inside a metal member, applying a ceramic coating that is unlikely to melt or peel at the temperature of heat treatment to the metal member and performing heat treatment of the metal member enables leaching of the molten liquid from the metal member to be suppressed by the ceramic coating.

(2) In some embodiments, in the method for manufacturing according to (1) described above,

the temperature T1 [° C.] in the step of performing heat treatment is expressed by (Ts−30)≤T1≤Ts+20, where Ts [° C.] denotes a solidus temperature of a composition of the metal member.

Performing heat treatment of the metal member in a vicinity of a melting point of the composition of the metal member increases the likelihood of a molten liquid being created inside the metal member. According to the method for manufacturing in (2) described above, leaching of a molten liquid from the metal member can be suppressed by the ceramic coating.

(3) In some embodiments, in the method for manufacturing according to (1) or (2) described above,

the metal member is any of a Ni-based heat-resistant alloy, a Co-based heat-resistant alloy, and a Fe-based heat-resistant alloy.

According to the configuration in (3) described above, leaching of a molten liquid from the metal member can be suppressed by the ceramic coating.

(4) In some embodiments, in the method for manufacturing according to any one of (1) to (3) described above,

in the applying step, the ceramic coating is applied to the metal member by thermal spraying.

According to the method for manufacturing in (4) described above, since the ceramic coating is applied to the metal member by thermal spraying, film formation can be expedited and deformation and distortion of the metal member due to the effect of heat can be suppressed as compared to cases where other methods are used.

(5) In some embodiments, in the method for manufacturing according to (4) described above,

a sprayed material used in the thermal spraying is yttria-stabilized zirconia.

According to the method for manufacturing in (5) described above, since yttria-stabilized zirconia has a large coefficient of linear expansion and a difference in coefficients of linear expansion from the metal member is reduced, a difference between a deformation amount of the metal member and a deformation amount of the ceramic coating during heat treatment decreases. As a result, peeling of the applied ceramic coating can be suppressed.

(6) In some embodiments, in the method for manufacturing according to (4) or (5) described above,

the ceramic coating is a dense vertical crack film.

Since a dense vertical crack film is capable of absorbing thermal deformation attributable to a difference in coefficients of linear expansion when the metal member expands or contracts, peeling of the applied ceramic coating can be suppressed by the method for manufacturing in (6) described above.

(7) In some embodiments, in the method for manufacturing according to any one of (4) to (6) described above,

the ceramic coating includes two or more layers.

When the application of the ceramic coating creates a state where a grain boundary is present at a boundary between ceramic particles, the effect of the ceramic coating of suppressing leaching of the molten liquid declines. However, according to the method for manufacturing in (7) described above, by performing multi-layer coating (overcoating) of the ceramic coating in two or more layers, even if a first layer is in the state described above, leaching of the molten liquid can be suppressed by the ceramic coating applied on top of the first layer.

(8) In some embodiments, in the method for manufacturing according to (7) described above,

the ceramic coating includes a first layer that is a dense vertical crack film and a second layer that is a dense film without vertical cracks.

According to the configuration in (8) described above, operational effects of both (6) and (7) above can be produced.

(9) In some embodiments, in the method for manufacturing according to any one of (4) to (8) described above,

the ceramic coating has a thickness of 150 μm to 1000 μm.

According to the method for manufacturing in (9) described above, stress inside the ceramic coating can be alleviated.

(10) In some embodiments, in the method for manufacturing according to any one of (1) to (3) described above,

in the applying step, the ceramic coating is applied to the metal member by slurry application.

According to the method for manufacturing in (10) described above, applying the ceramic coating to the metal member by slurry application enables the ceramic coating to be applied even to complex surfaces of metal members such as that including an internal structure. In addition, since slurry application does not require a blasting operation which is required in thermal spraying, workability can be improved.

(11) In some embodiments, in the method for manufacturing according to (10) described above,

the slurry application is performed by spraying a slurry with a high-pressure spray, and

blasting is performed on the metal member before the slurry application and drying is performed after the slurry application.

Compared to thermal spraying, slurry application has several disadvantages such as management of a workpiece in a heat treatment process being more difficult due to weaker adhesion. However, according to the method for manufacturing in (11) described above, adhesion can be improved.

(12) In some embodiments, in the method for manufacturing according to any one of (1) to (11) described above,

the preparing step includes molding the metal member by 3D additive manufacturing.

When strength of a metal member molded by 3D additive manufacturing is lower than strength of a metal member formed by casting or forging, the metal member must be subjected to heat treatment at a temperature in a vicinity of a melting point in order to increase strength. However, since leaching of a molten liquid from the metal member is likely to occur, applying a ceramic coating before heat treatment to a metal member molded by 3D additive manufacturing as in the method for manufacturing according to (12) described above enables leaching of the molten liquid from the metal member to be suppressed.

According to at least one embodiment of the present disclosure, even when a molten liquid is created inside a metal member, applying a ceramic coating that is unlikely to melt or peel at the temperature of heat treatment to the metal member and performing heat treatment of the metal member enables leaching of a molten liquid from the metal member to be suppressed by the ceramic coating.

### BRIEF DESCRIPTION OF DRAWINGS

FIG. 1 is a flow chart showing a method for manufacturing a metal molded article according to a first embodiment of the present disclosure;

FIG. 2 is a diagram showing a relationship between temperature (° C.) and liquid phase ratio (mol %);

FIG. 3 is a schematic view showing a state where a metal member is subjected to a heat treatment in the method for manufacturing a metal molded article according to the first embodiment of the present disclosure; and

FIG. 4 is a diagram schematically representing a situation where a molten liquid leaches out from a surface of a metal member.

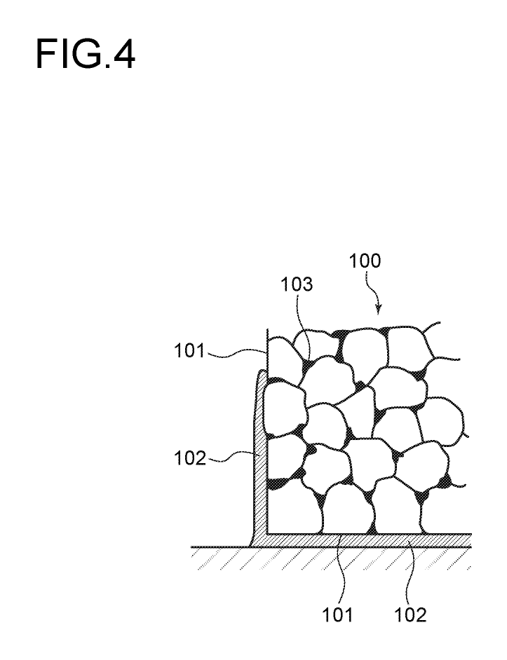

### DETAILED DESCRIPTION

Hereinafter, some embodiments of the present invention will be described with reference to the accompanying drawings. However, it is to be understood that the scope of the present invention is not limited to the embodiments described below. Dimensions, materials, shapes, relative arrangements, and the like of components described in the embodiments shall be interpreted as illustrative only and not limitative of the scope of the present invention.

### First Embodiment

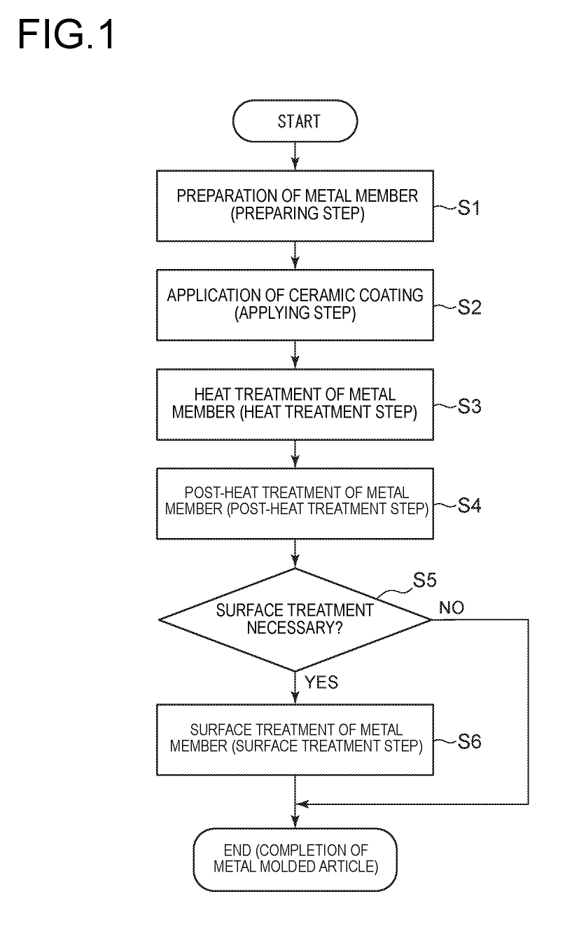

A method for manufacturing a metal molded article according to a first embodiment of the present disclosure will be described with reference to the flow chart in FIG. 1.

First, in step S1, a metal member is prepared (a preparing step). The preparing step includes, for example, manufacturing the metal member by casting, forging, 3D additive manufacturing, and the like or procuring the metal member from a location other than where the present method for manufacturing is to be performed. In addition, the metal member is manufactured using a Ni-based heat-resistant alloy, a Co-based heat-resistant alloy, a Fe-based heat-resistant alloy, or another metal.

Next, in step S2, a ceramic coating is applied to a surface of the metal member (an applying step). The ceramic coating can be applied to the surface of the metal member by thermal spraying such as atmospheric plasma spraying. Compared to other methods, thermal spraying is capable of expediting film formation and suppressing deformation and distortion of the metal member due to the effect of heat. In step S3 following step S2, heat treatment is performed on the metal member in a vicinity of a melting point of a composition of the metal member (a heat treatment step). Since the ceramic coating applied to the surface of the metal member is exposed to high temperature during the heat treatment, the ceramic coating favorably has (a) several characteristics from a perspective requiring that the ceramic coating be usable in high-temperature environments and (b) several characteristics from a perspective of denseness for suppressing leaching, from the metal member, of a molten liquid that may be created during the heat treatment.

With respect to the characteristics of (a) described above, when there is a large difference between respective coefficients of linear expansion of the ceramic coating and the composition of the metal member, a difference in respective deformation amounts of the ceramic coating and the metal member during heat treatment increases, thereby creating a risk that the ceramic coating may peel away from the metal member. In consideration thereof, in order to reduce the difference between respective coefficients of linear expansion of the ceramic coating and the composition of the metal member, the ceramic coating is favorably applied in step S2 using a sprayed material with a large coefficient of linear expansion. Since reducing the difference between respective coefficients of linear expansion of the ceramic coating and the composition of the metal member reduces the difference between the deformation amount of the metal member and the deformation amount of the ceramic coating during heat treatment, peeling of the ceramic coating during heat treatment can be suppressed. For example, yttria-stabilized zirconia (YSZ) can be used as such a sprayed material.

In addition, the ceramic coating is favorably a dense vertical crack (DVC) film. When the ceramic coating is a DVC film, since thermal deformation attributable to a difference in coefficients of linear expansion when the metal member expands or contracts can be absorbed, peeling of the applied ceramic coating can be suppressed.

Furthermore, a thickness of the ceramic coating is favorably within a range of 5 μm to 1000 μm. By setting the thickness of the ceramic coating within this range, stress inside the ceramic coating can be alleviated. With respect to a lower limit of thickness, since a surface roughness of a formed article is Ra 5 μm or more, a thickness of 5 μm or more is favorable. On the other hand, with respect to an upper limit of thickness, when a film thickness which is adjustable by film formation by thermal spraying or slurry application increases, an effect of thermal stress due to differences in residual stress and coefficients of linear expansion during film formation by thermal spraying increases and peel resistance of the ceramic coating declines. Therefore, the thickness is desirably managed within a range where characteristics of both resistance to leaching and peel resistance are satisfied. Although a decline in peel resistance is acceptable up to a thickness of 1000 μm, the thickness is desirably 150 μm or less in consideration of film formation cost.

With respect to the characteristics of (b) described above, a particle diameter of sprayed particles must be equal to or larger than a size of a grain boundary of the composition of the metal member, and a range of such a particle diameter is 10 μm to 125 μm. In addition, porosity of the ceramic coating is favorably 3% or less. In order to realize porosity of 3% or less, for example, the ceramic coating may be applied to the metal member by spraying the surface of the metal member with completely melted sprayed particles from a distance of 70 mm or less.

When the particle diameter of the sprayed particles is equal to or larger than the size of the grain boundary, the ceramic coating is basically able to suppress leaching of a molten liquid. However, when the application of the ceramic coating creates a state where a grain boundary is present at a boundary between particles, the effect of suppressing leaching of the molten liquid by the ceramic coating declines. On the other hand, by performing multi-layer coating (overcoating) of the ceramic coating in two or more layers, even if a first layer is in such a state, the effect of suppressing leaching of the molten liquid by the ceramic coating can be maintained by further applying the ceramic coating on top of the first layer. In this case, a material, thickness, porosity, and the like of at least one layer other than the first layer may be the same as or may differ from those of the first layer. For example, the first layer may be a dense vertical crack film and a second layer may be a dense film without vertical cracks. Since film stress is applied to an interface between a base material and the first layer, peel resistance can be secured for this portion by applying a dense vertical crack film to the first layer. Since the second layer is subjected to smaller film stress, resistance to leaching can be improved by applying a dense film without vertical cracks to the second layer.

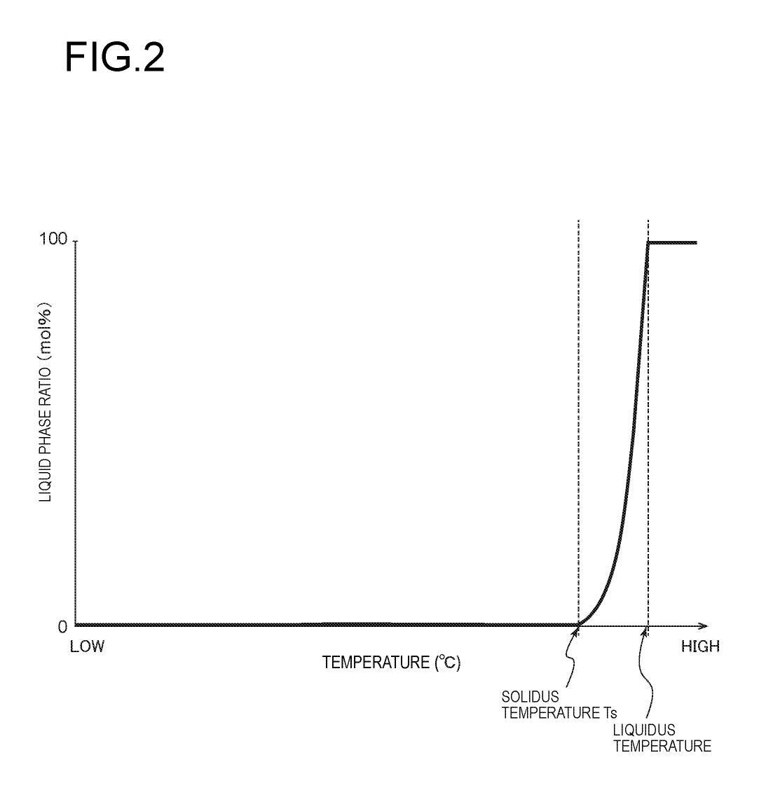

While heat treatment is performed on the metal member in step S3 as described above, a temperature T1 [° C.] of the heat treatment is expressed by (Ts−70)≤T1≤Ts+30 and favorably expressed by (Ts−30)≤T1≤Ts+20, where Ts [° C.] denotes a solidus temperature of the composition of the metal member. During the heat treatment, the temperature T1 may be changed with time within such ranges or the temperature T1 may be fixed at a constant value regardless of time. A solidus refers to a line indicating a boundary between a region where solid and liquid are in equilibrium and a region where solid exists in a stable manner on a temperature-composition map of a multicomponent system, and a solidus temperature Ts refers to a temperature at which solid starts to melt (a temperature at a point where a liquid phase ratio starts to increase from 0) as shown in FIG. 2. FIG. 2 is a diagram showing a relationship between temperature (° C.) and liquid phase ratio (mol %).

Since the heat treatment is performed in a vicinity of a melting point of the composition of the metal member, a grain boundary with a low melting point may partially melt to create a molten liquid. When the molten liquid leaches out from the metal member, the likelihood of a defect being created inside the metal member increases. Since this defect is an opening defect which continues from the surface of the metal member, the defect cannot be eliminated even in a post-treatment step to be described later and strength of the metal member declines. However, in the first embodiment, since the ceramic coating that is unlikely to melt or peel during the heat treatment is applied to the surface of the metal member in step S2, even when a molten liquid is created during the heat treatment, leaching of the molten liquid from the metal member can be suppressed. As a result, defects created in the metal member can be reduced and a decline in strength can be mitigated.

As shown in FIG. 1, in step S4 following step S3, post-heat treatment of the metal member is performed (a post-heat treatment step). As the post-heat treatment of the metal member, vacuum heat treatment of the metal member may be performed, hot isostatic pressing (HIP) treatment may be performed in which heat treatment of the metal member is performed while applying pressure, or both of these treatments may be performed.

Next, in step S5, a determination of whether or not surface treatment of the metal member is to be performed is made based on whether or not the ceramic coating needs to be removed. When it is determined that surface treatment is necessary in step S5, in step S6, a metal molded article is completed by performing surface treatment of the metal member including removal of the ceramic coating by blasting or the like (a surface treatment step). When it is determined that surface treatment is unnecessary in step S5, a metal molded article is completed without performing surface treatment. Since ceramics are vulnerable to impact, the ceramic coating can be readily removed by blasting or the like.

As described above, by applying a ceramic coating that is unlikely to melt or peel at a temperature of heat treatment to a metal member and performing heat treatment of the metal member, even when a molten liquid is created inside the metal member, leaching of the molten liquid from the metal member can be suppressed by the ceramic coating. As a result, defects created in the metal member can be reduced and a decline in strength can be mitigated.

### Second Embodiment

Next, a method for manufacturing a metal molded article according to a second embodiment will be described. The method for manufacturing a metal molded article according to the second embodiment represents a change in a method for applying a ceramic coating with respect to the first embodiment. In the second embodiment, a detailed description of same constituent features as the first embodiment will be omitted.

In the method for manufacturing a metal molded article according to the second embodiment of the present disclosure, in step S2 (refer to FIG. 1) after step S1, a ceramic coating is applied to a metal member by slurry application. Other steps are the same as those of the first embodiment. Therefore, hereinafter, the slurry application in step S2 will be described in detail.

As an example of the slurry application, the metal member prepared in step S1 can be dipped into a slurry of ceramic particles that constitute a raw material of the ceramic coating. Accordingly, the ceramic coating can be applied to a surface of the metal member.

Slurry application including such dipping is an effective method for applying a ceramic coating to complex surfaces of metal members such as that including an internal structure. Since thermal spraying entails directionality in spraying of a sprayed material, there may be cases where film formation cannot be performed on an inner surface of the internal structure. However, with slurry application, since the slurry is able to penetrate inside the internal structure, the ceramic coating can also be applied to the inner surface of the internal structure.

In addition, since slurry application generally does not require a blasting operation which is required in thermal spraying, workability can also be improved. Furthermore, when thermal spraying is compared with, for example, dipping, while the former requires a thermal spraying film formation apparatus and results in an extensive operation, an operation for the latter can be readily performed with simple equipment.

However, compared to thermal spraying, slurry application has several disadvantages such as management of a workpiece in a heat treatment process being more difficult due to weaker adhesion. Countermeasures that can be taken in order to improve adhesion include performing drying after the application at a relatively high temperature, blasting the metal member before the application, and spraying a slurry of ceramic particles with a high-pressure splay instead of dipping.

As a coating agent of the slurry application, zirconia-based coating agents (for example, Zircoat Y-11 and Y-12 (Osaka-Zircon Co., Ltd.)) and silica-based coating agents (for example, SNOWTEX (registered trademark) 30 or SNOWTEX (registered trademark) 40, SNOWTEX (registered trademark) and zircon, SNOWTEX (registered trademark) and alumina, MP-4540M, and NanoUse (registered trademark) ZR-40BL (Nissan Chemical Corporation)) can be used.

After applying the ceramic coating to the surface of the metal member by slurry application in step S2, a metal molded article is completed by performing step S3 to step S5 (and step S6 when necessary) in a similar manner to the first embodiment. In the second embodiment, even when a molten liquid is created during heat treatment, leaching of the molten liquid from the metal member can be suppressed by the ceramic coating applied to the surface of the metal member in a similar manner to the first embodiment. As a result, defects created in the metal member can be reduced and a decline in strength can be mitigated.

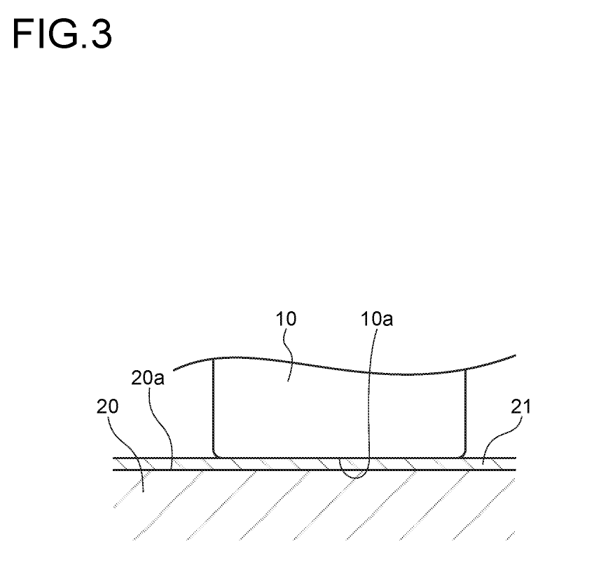

In each of the first and second embodiments, the heat treatment of step S3 is performed as shown in FIG. 3 by placing a metal member 10 on top of a surface 20a of a setter 20. By applying a ceramic coating 21 on top of the surface 20a in advance, even when a ceramic coating is not applied to a portion 10a of a surface of the metal member 10 which comes into contact with the ceramic coating 21 on the surface 20a, leaching of a molten liquid from the metal member 10 can be suppressed by the ceramic coating 21. Even when a ceramic coating is applied to the portion 10a of the surface of the metal member 10, by further applying the ceramic coating 21 on top of the surface 20a, leaching of a molten liquid from the metal member 10 can be further suppressed.

While casting, forging, and 3D additive manufacturing are exemplified as methods of manufacturing a metal member in step S1 (the preparing step) of both the first and second embodiments, the method for manufacturing according to the present disclosure is particularly effective when the metal member is molded by 3D additive manufacturing. Generally, a metal member molded by 3D additive manufacturing has low strength and requires heat treatment at a temperature in the vicinity of a melting point. Therefore, since the likelihood of an occurrence of leaching of a molten liquid from the metal member increases, by applying a ceramic coating on the surface of the metal member, leaching of the molten liquid can be suppressed.

In step S2 of both the first and second embodiments, while the ceramic coating is performed by only thermal spraying or by only slurry application, thermal spraying and slurry application may be performed in combination. For example, when providing the ceramic coating in a two-layer structure, the first layer may be applied by thermal spraying and the second layer may be applied by slurry application. Obviously, a reverse sequence may be adopted, and when providing the ceramic coating in a structure of three or more layers, each layer can be applied by either thermal spraying or slurry application.

1. A method for manufacturing a metal molded article, the method comprising the steps of:
preparing a metal member;
applying a ceramic coating to the metal member; and
performing heat treatment of the metal member to which the ceramic coating has been applied, wherein
a temperature T1 [° C.] in the step of performing heat treatment is expressed by (Ts−70)≤T1≤Ts+30, where Ts [° C.] denotes a solidus temperature of a composition of the metal member.

2. The method for manufacturing a metal molded article according to claim 1, wherein the temperature T1 [° C.] in the step of performing heat treatment is expressed by (Ts−30)≤T1≤Ts+20, where Ts [° C.] denotes a solidus temperature of a composition of the metal member.

3. The method for manufacturing a metal molded article according to claim 1, wherein the metal member is any of a Ni-based heat-resistant alloy, a Co-based heat-resistant alloy, and a Fe-based heat-resistant alloy.

4. The method for manufacturing a metal molded article according to claim 1, wherein, in the applying step, the ceramic coating is applied to the metal member by thermal spraying.

5. The method for manufacturing a metal molded article according to claim 4, wherein a sprayed material used in the thermal spraying is yttria-stabilized zirconia.

6. The method for manufacturing a metal molded article according to claim 4, wherein the ceramic coating is a dense vertical crack film.

7. The method for manufacturing a metal molded article according to claim 4, wherein the ceramic coating includes two or more layers.

8. The method for manufacturing a metal molded article according to claim 7, wherein the ceramic coating includes a first layer that is a dense vertical crack film and a second layer that is a dense film without vertical cracks.

9. The method for manufacturing a metal molded article according to claim 4, wherein the ceramic coating has a thickness of 150 μm to 1000 μm.

10. The method for manufacturing a metal molded article according to claim 1, wherein, in the applying step, the ceramic coating is applied to the metal member by slurry application.

11. The method for manufacturing a metal molded article according to claim 10, wherein
the slurry application is performed by spraying a slurry with a high-pressure spray, and
blasting is performed on the metal member before the slurry application and drying is performed after the slurry application.

12. The method for manufacturing a metal molded article according to claim 1, wherein the preparing step includes molding the metal member by 3D additive manufacturing.

13. A metal molded article manufactured by the method for manufacturing a metal molded article according to claim 1.
